(19) United States
(12) Patent Application Publication
(10) Pub. No.: US 2004/0251446 A1
(43) Pub. Date: Dec. 16, 2004

(54) Aqueous fire retardant

(76) Inventor: George Mantanis, Lamia (GR)

Correspondence Address: LADAS & PARRY, 26 WEST 61ST STREET, NEW YORK, NY, 10023, US

(21) Appl. No.: 10/478,249

(22) PCT Filed: Jun. 17, 2002
(86) PCT No.: PCT/GB02/00037

(30) Foreign Application Priority Data
Jun. 15, 2001 (GB) 0114653.9

(51) Int. Cl. A62D 1/00

(52) U.S. Cl. 252/8.05

(57) ABSTRACT

A fire retardant composition that is halogen-free comprises an aqueous solution of an amine, a borate and a phosphate. The claimed composition is effective in providing wood-based panels like medium- or high-density fibreboards with high fire resistance without a diminution in their physical and mechanical properties.

A fire retardant composition which is halogen-free and comprises an aqueous solution of a tertiary amine, a borate and a phosphate.

### DESCRIPTION OF THE INVENTION

The invention relates to a fire retardant composition for use in treating wood-based panels such as fibreboards. The fire retardant composition of this invention is highly effective, penetrates rapidly into the wood structure, is environmentally friendly and non-corrosive, and is manufactured without the use of toxic materials (i.e. halogen compounds).

Residential and commercial fires annually claim the lives of hundreds of people and cause numerous damages in property. As a result, increased attention has focused on methods for eliminating or reducing the risk of fire by substituting combustible materials with fire retardant materials whenever possible. Although fire retardants are somewhat more expensive than equivalent combustible materials, their use in high risk environments is becoming increasingly p u a, since this approach avoids many of the problems associated with active fire retardant systems such as maintenance and operational difficulties.

One problem associated with fire retardant materials is that they tend to have poorer physical properties and to be less aesthetically attractive than comparable materials which have not been treated for fire retardancy. Some fire retardant treatments tend to produce unsightly deposits on the surface of the treated wood substrates, while others leave an undesirable residue. In addition, the fire retardant treatment may result in a significant loss of strength in the treated material that can be a serious disadvantage for some products such as high density fibreboard (HDF) or medium density fibreboard (MDF).

Another problem relates,, to the environmental safety of the fire retardant material and its components. Many of the materials that are used to manufacture fire retardants are complex brominated and/or chlorinated chemicals. These complex chemicals are not only unsafe to handle, but can also emit toxic fumes in the presence of fire. Toxic fumes are frequently more dangerous to humans than the fire itself. Consequently, not only should the fire retardant reduce substantially the flammability of the substrate, but it should also be safe to human occupants during flaming conditions.

Rock (U.S. Pat. No. 4,514,327) disclosed a fire retardant composition consisting of ammonium sulfate, borax, boric acid and monoammonium phosphate, and the method for preparing the same. The combined fire retardant properties of the final composition are greater than the fire retardant properties of the individual ingredients. When formulated and treated in accordance with the disclosed composition, wood products such as paneling and flooring, fabric products such as cotton, wool and rayon and the like which are normally flammable are for all practical purposes non-combustible. The application of the liquid composition can be performed through a consecutive vacuum, pressure, vacuum process or through dipping, spraying, brushing or rolling techniques.

Hsu (U.S. Pat. No. 5,246,652) disclosed a novel method for producing a wood composite treated with a soluble boron compound. Either a phenol-formaldehyde resole or novolac type resin can be used as the binder for a wood furnish. The wood furnish is surface treated with either the resole type resin or novolac resin together with a water soluble boron compound whereafter the surface treated wood furnish is formed into a mat and then consolidated in a press. When novolac is used as the resin, the consolidation takes place under sufficient pressure, heat and time in order to cure the novolac type resin and to form the wood composite. Optionally, the curing of the novolac resin can be promoted by injecting the compressed mat with steam, rather than by means of heated press platens. However, if a resole type resin is employed as the binder, while in its consolidated condition, pressurized steam is injected into the consolidated mat for a time sufficient to cure the binder and form the composite. The wood composite so produced and which contains the soluble boron compound, exhibits acceptable internal bond strength, and due to the inclusion of the boron compound, renders the composite less susceptible to biological attack and more retardant to fire.

Riker (U.S. Pat. No. 5,405,555) disclosed an aqueous fire retardant solution, a method of making said solution, and a method of using said solution as a coating for cellulosic materials and cellulosic containing materials. The fire retarding solution consists essentially of ammonium sulfate 3-10% by weight, boric acid 1-5% by weight, borax 0.3-1% by weight, hydrogen peroxide 1-5% by weight, and optionally a surfactant and/or an alkyl phthalate ester and can be applied by coating, spraying or impregnation to cellulosic materials.

Thompson (U.S. Pat. No. 5,151,127) described chemical compositions applied to wood or cellulose products, which combine the functions of preservation and protection against deterioration due to molds, fungi, insects, weather, fire and flame. These consist of nine combinations of various of the following compounds: borax, boric acid, boric oxide, urea, magnesium chloride, ammonium polyphosphate solution, ammonium thiosulphate solution and triethylamine in a aqueous solution mixed with the specific acrylic resin compatible to the compounds. These compositions are applied to wood and cellulose products by spraying, brushing, rolling, pouring, dipping, immersing or pressure impregnation, depending on the material being treated and the purpose for which it is intended. The inclusion of the specific acrylic resin in each of these nine different compositions prevents the other chemical compounds, which are normally water soluble, from leaching or washing out of the products after application. None of the disclosed compositions includes both an amine and a phosphate however.

Lewchalermwong (U.S. Pat. No. 4,725,382) claimed a water soluble fire retardant composition that utilizes pH control to afford a fire retardant material of low corrosiveness, said fire, retardant composition being a dry mix that consists essentially of non-hygroscopic sources of B₂O₃, P₂O₅ and NH₃ that provide about 5-23 wt % B₂O₃, about 32-51 wt % P₂O₅, and about 11-23 wt % NH₃. The non-hygroscopic source of NH₃ can be an ammonium phosphate, ammonium borate, a mixture of ammonium phosphates, a mixture of ammonium borate and an ammonium phosphate, a mixture of ammonium borate and said mixture of ammonium phosphates, ammonia gas, or a mixture thereof. The invention is further illustrated by examples in all of which the fire retardant composition comprises boric acid, monoammonium phosphate and diammonium phosphate. The composition is applied to wood by vacuum impregnation. The patent teaches against the use of hygroscopic organic compounds.

It is one of the objectives of the present invention to provide a fire retardant composition suitable for use in the production of composite wood panels such as dry processed fibreboards.

It is a further objective of the invention to provide a fire retardant composition which is highly effective, penetrates rapidly into the wood structure, is environmentally friendly and non-corrosive, and is manufactured is without the use of toxic materials (i.e. halogen compounds).

The fire retardant composition of the invention comprises an aqueous solution of from 1 to 10 weight percent of an amine preferably a tertiary amine, from 3 to 20 weight percent of a borate, from 20 to 50 weight percent of a phosphate and water in an amount sufficient to complete said solution.

The proposed fire retardant composition is prepared by first formulating an aqueous borate solution which,is highly stable over time. A large amount of a phosphate, preferably monoammonium or diammonium phosphate, is then added to and mixed with the aqueous borate solution. It is indeed an innovative feature of the invention the high water solubility of the borate based solution achieved by the addition of a tertiary amine such as trimethylamine, tributylamine, and the like. An ammonium phosphate based solution alone could not penetrate effectively into the wood cell wall and should, therefore, be combined with additional ingredients such as a tertiary amine to achieve a sufficient and effective impregnation. The synergistic effect of the amine, phosphate and borate based additives is illustrated but not limited in the example described herein. The resulting solution has a pH in the range of 6.0 to 8.5 and is visually clear.

The borate may be selected from a group of borax and boric acid, or mixtures thereof. The tertiary amine may be selected from a group comprising between 6 and 12 carbon atoms.

The fire retardant solution according to the invention comprising from 1 to 10 weight percent of a tertiary amine, from 3 to 20 weight percent of a borate, from 20 to 50 weight percent of a phosphate and water in an amount sufficient to complete said solution, may be prepared by a method consisting essentially by loading water in a vessel with agitator and heating to a temperature from 50° to about 60° C. and admixing with said water the above mentioned components at said levels and sequence.

Another method of preparation of the claimed fire retardant solution comprises loading water in a vessel with agitator and adding from 1 to 10 weight percent of a tertiary amine, from 20 to 50 weight percent of a phosphate and from 3 to 20 weight percent of a borate while stirring and keeping temperature at 20-23° C. A clear solution is obtained after 15 to 20 min.

In a preferred embodiment, the fire retardant composition can be applied to the wood fibres used for fibreboard production by employing the known blow line blending technique, which is applied in the dry processed fibreboard industry. A blow line is a conventional device used in most fibreboard plants to enable the complete mixing of the bonding mixture with the wood fibres. By entering the blow line section, the fibres are expanded and thus separated from each other and at a later point are sprayed with the bonding mixture, while turbulent flow conditions prevail. The fire retardant may thus be injected in the blow line at an appropriate point and absorbed rapidly into the wood fibre, typically in only a few milliseconds. A gluing mix composition based on a urea-formaldehyde (UF) or melamine-urea-formaldehyde (MUF) resin and its additives is also injected in the blow line. Notably, the fire retardant may be injected upstream or downstream of the resin addition. The fibres are next passed to a dryer unit such as a flash tube dryer. The dried fibres are formed to mats and hot pressed to fibreboards.

The level of addition of fire retardant on wood fibres on a dry basis can be between 9 to 18 weight percent depending on the requested class of fire resistance.

Fire retardant treated fibreboards prepared in accordance with the present invention have been found to exhibit excellent fire resistance without a diminution in their mechanical strength properties. Specifically, the internal bond strength and bending characteristics of these boards have been retained at high levels, while at the same time the formaldehyde emission of the boards as measured by the conventional perforator method has been reduced substantially.

The following example further illustrates the embodiments of this invention and is provided for illustrative purposes only and not meant to limit the invention as more fully set forth in the appended claims and foregoing description.

### EXAMPLE

A fire retardant composition consisting essentially of 4 weight percent tributylamine, 20 weight percent borax and 30 weight percent monoammonium phosphate was prepared. The aqueous mixture became clear after it was left stirring for ½ hour at 60 degrees Celsius. The resulting solution had a pH of about 8.2.

Three MDF boards were produced using the known dry fibreboard process including the blow line blending technique. The same addition level of an E2 type MUF resin of 20% was used in all cases. At an 18% addition level (on dry wood) of fire retardant, the following were used: A) an aqueous (35% solids) diammonium phosphate solution, and B) the prepared aqueous composition. An aqueous solution of boric acid could not be tried out since boric acid is almost insoluble to water. The fire retardant solutions and the MUF resin were injected in the blow line. The mechanical and swell properties of the resultant boards were evaluated. The boards were also examined for fire resistance using the French standard NF P 92-501 by measuring surface flammability using a radiant energy heat source. The results are shown in the next table:

TABLE

| | Reference | A | B |
|---|---|---|---|
| FR addition level | 0% | 18% | 18% |
| (on dry basis) | | diammonium | prepared |
| | | phosphate | solution |
| Resin | 20% MUF resin | | |
| Tensile strength (lB), | 1.23 | 0.32 | 0.92 |
| N/mm² | | | |
| Thickness swell after | 6.5 | 21.3 | 9.5 |
| 24 h immersion in | | | |
| water, % | | | |
| Perforator, mg/100 g | 56.1 | 9.0 | 6.4 |
| Bending strength | 31.1 | 16.4 | 34.5 |
| (MOR), N/mm² | | | |
| FR classification | FR Class A4 | FR Class A2 | FR Class A1 |
| (NF P 92-501) | | | |

From the results above, it becomes apparent that the board treated with diammonium phosphate has low mechanical properties, notably internal bond strength, while its fire retardancy properties were lower compared with that of the board produced using the claimed fire retardant solution. The latter board exhibited very high strength characteristics, retained its IB properties in relation to the reference board produced, while simultaneously it showed very high resistance to fire. It actually reached the requirements for the highest class (Class A1) according to the known French method used.

1. An aqueous fire retardant solution consisting of:
a) from 1 to 10 parts by weight of a tertiary amine;
b) from 3 to 20 parts by weight of boric acid or a borate; and
c) from 20 to 50 parts by weight of a phosphate.

2. A fire retardant solution according to claim 1 in which the tertiary amine has from 6 to 12 carbon atoms.

3. A fire retardant solution according to claim 1, wherein component (b) is borax or boric acid, or a mixture thereof.

4. A fire retardant solution according to claim 1, wherein component (c) is monoammonium phosphate or diammonium phosphate, or a mixture thereof.

5. A fire retardant solution according to claim 1, wherein the pH of said solution is from 6.0 to 8.5.

6. A fire retardant solution according to claim 1, which is halogen-free.

7. A fire-retardant solution according to claim 1, comprising 40 to 60 parts by weight of water.

8. A fibreboard product treated with a fire-retardant solution as claimed in claim 1.

9. A method of making fire-resistant fibreboard wherein a fire retardant solution as claimed in claim 1 and a bonding resin are sprayed onto the fibres, the sprayed fibres are dried, formed into mats and hot pressed to form fibreboards.

10. A method according to claim 9, wherein the fire-retardant solution is injected into a blow line which is used to mix the bonding resin with the fibres.

11. Fibreboard obtainable by a method as claimed in claim 9.
